(19) United States
(12) Patent Application Publication
(10) Pub. No.: US 2016/0250009 A1
(43) Pub. Date: Sep. 1, 2016

(54) FLOSSING DEVICE WITH ASYMMETRICALLY CURVED AND BULBOUS HANDLE

(71) Applicants: Michael Thomas Taciuk, (US); Sebastian Jesus Munoz, (US)

(72) Inventors: Michael Thomas Taciuk, Edmonton (CA); Sebastian Jesus Munoz, Vancouver (CA)

(21) Appl. No.: 14/647,122

(22) PCT Filed: Nov. 26, 2012
(86) PCT No.: PCT/IB2012/056741

§ 371 Date: Sep. 10, 2015

(51) Int. Cl. A61C 15/04

(52) U.S. Cl. CPC A61C 15/046

(57) ABSTRACT

A hand held flossing device with a handle that is asymmetrically curved, such that when the device is oriented to clean between the lower back teeth, the axis of the handle is curved sideways and downwards away from the mouth. The curvature of the handle may also continue into the neck of the device. The handle also has a bulbous portion having an enlarged surface area for gripping firmly with minimal force. This provides for improved comfort and easier use, allowing the user's wrist joint to be used for manipulating the device. Further features are a common channel for guiding the floss and a common fastening point, allowing both ends of the floss to be guided and attached simultaneously.

### TECHNICAL FIELD

The present invention generally relates to the field of hand held flossing devices and, more particularly, is concerned with a flossing device with a handle that is asymmetrically curved and has a bulbous region.

### BACKGROUND

Flossing, or the use of interdental cleaners, is essential to clean bacterial plaque from between teeth that regular brushing cannot reach. Including flossing as an integral part of one's regular oral care reduces the amount of periodontal disease. Evidence suggests that periodontal disease can be a risk factor for cardiovascular and respiratory disease. It also has been shown that periodontal disease may increase the risk of premature or low birth weight babies by a factor of seven. Bleeding gums, bone loss and an increase in pocket depths may be early indicators of diabetes. Periodontal disease has also been known to be interrelated with diabetes. Bleeding gums, bone loss and an increase in pocket depths may be an early indicator of diabetes. Diabetes sufferers are more susceptible to periodontal disease. The above statements emphasize the importance of research and development of a device that is necessary to help, and transform, the act of flossing.

Floss has been irreplaceable to date, being a convenient, personal and effective form of interdental hygiene. However, there has been a void in defining the proper habit, posture, act or experience of flossing using different devices over the years. This void has not been filled, undermining the benefits flossing, due to the complicated process of handling floss, maintaining a suitable pressure and navigating tight interdental spaces. Different studies have been held to show that many people forgo flossing, which is necessary for proper mouth hygiene.

Many people find it difficult or inconvenient to use existing flossing devices, which traditionally have thin or short handles. Using a comfortable amount of force it is not possible to close one's hand around such handles with enough grip to manipulate them successfully. Instead, they must be manipulated with the fingers or with an excessively tight grip. As a result, such flossing devices are tricky and uncomfortable to use.

The duration of time needed for effective flossing has not been considered, which is reflected by the fact that existing flossing devices require manipulation with tensed fingers, resulting in muscle exhaustion, numbness, tickling and creation of undue stress on a daily basis. Current devices are more related to toothbrushes than to an instrument that provides a more developed sensitivity, more precision and is conducive to the patience and possibly extra time that flossing requires. A lack of ergonomics in existing flossing handles and picks does not facilitate control of the tensioned floss, creating injuries in gums and making the experience unnecessarily unpleasant.

Existing flossing instruments do not intentionally set a posture for the hand, creating an undefined, digging, somewhat thoughtless, and mirror-dependent type of flossing. Many flossing devices subject the body to an uncomfortable position, making the whole act of flossing unbearable. Discomfort may arise from a wide open mouth or a tensed jaw, arm, wrist, or inner palm, caused, for example, by using a straight and thin flossing instrument.

While there have been advances in the area of orthodontic flossing devices, none are equipped with a handle that is intended to easily control the strength in the tip.

Floss placement is usually a uni-directional threading process through narrow channels, making it difficult to place. This is exacerbated by the floss usually coming off during the act of flossing or having to be replaced because of usage. There is a lack of understanding of the forces that occur during flossing, which is evidenced by fixing mechanisms that are considered as locks. A solution in many cases is to incorporate a knob around which an undefined quantity of floss is wrapped. Replacement of a used floss segment is slow. These devices often also require the floss to change planes, complicating even more its placement. Floss is attached directly to the knob with no prior reduction of tension, making the knob and the tips the only pressure points. Furthermore, the end of the floss is not secured, causing it to unravel in use. There is always flexure in the device material, which is plastic in most cases, allowing the floss to slip or sag. In other devices, there are complicated mechanisms, with gears or pulleys, for example.

Hand held flossing devices are often created for users without braces, for non-orthodontic mouth cavities.

There does not appear to be an existing flossing instrument that embraces a connection between the gum, tooth, body and, in the sense of reducing frustration, the mind.

Some examples of existing flossing devices are as follows. U.S. Pat. No. 4,008,728 discloses a flossing device containing a reservoir compartment for floss. U.S. Pat. No. 5,183,064 discloses a flossing device with needle eyes in the posts for holding the floss. U.S. Pat. No. 5,375,615 describes a flossing device that holds a spool of floss. U.S. Pat. No. 5,573,021 discloses a flossing device with an offset head. U.S. Pat. No. 6,422,867 discloses a motorized flossing device. U.S. Pat. No. 7,234,475 discloses a flossing device with a head that can be bent from a storage position to a flossing position. US Patent Application 2009/0025748 describes a flossing device with a universal joint.

### SUMMARY OF INVENTION

After carefully studying the relationship between traditional flossing devices and the orientation of a user's hand when using such devices, the inventors have made several observations. Firstly, when the user's hand is held to the mouth in a flossing position, with the fingers curled in a relaxed state, the cavity enclosed by the fingers has a convex upper surface. Secondly, the cavity enclosed by the fingers is directed downwards, away from the mouth. Thirdly, the cavity is somewhat bulbous. Fourthly, the cavity has a sideways curvature, curving outwards from the thumb to the little finger, away from the centre line of the body. By making a handle that largely conforms to these features of the hand and the position in which it is most comfortably held, a flossing device that is more comfortable to use can be made. The resulting improvement in the flossing experience can change one's attitude towards it. Furthermore, because minimal gripping force is required to hold the flossing device firmly in the hand, it can be manipulated using the wrist. This adds to the comfort of use of the flossing device because it is much easier for the user to use his wrist as an articulation than to use his fingers for manipulation.

In contrast to prior art flossing devices, which have been fashioned as if they were little more than handles, the present invention provides a device that is like a bodily extension of the hand. The present invention is a flossing instrument that can be used to carefully regulate pressure on the gums, teeth and the floss.

The present invention is directed to a hand held flossing device with a handle that is asymmetrically curved. In addition, the neck and head extending from the handle may be angled or otherwise integrated with the curvature of the handle. More specifically, when the flossing device is oriented as if to clean between one's lower back teeth, the axis of the handle is curved in sideways and downwards directions away from the aperture of the mouth. In addition, the handle has a bulbous portion, with convex upper and lower surfaces for lightly gripping with one's hand.

Disclosed herein is a flossing device comprising: a head having two tips between which floss can be mounted in a line, wherein the line defines a reference plane that bisects the line and is perpendicular to the line; a neck joined to the head; a handle joined to the neck, wherein the handle has a curvilinear axis that is outside the reference plane.

Also disclosed is a method of manufacturing a flossing device comprising: forming a head having two tips between which floss can be mounted in a line, wherein the line defines a reference plane that bisects the line and is perpendicular to the line; forming a neck joined to the head, the neck having a curved portion over which the floss is guided, said curved portion providing friction to assist in maintaining tension in the line of floss; forming a handle joined to the neck, wherein the handle has a monotonically curved curvilinear axis that is outside the reference plane and a bulbous portion, wherein the curvilinear axis has an outer side that is facing away from the reference plane and the outer side is convex; attaching, to the handle or neck, a single fastener for wrapping multiple strands of floss around and for attaching said multiple strands to the flossing device, the fastener comprising a slot into which the floss can be wedged in order to maintain tension in the line of floss; and forming a channel between the two tips and the fastener for guiding multiple strands of floss simultaneously.

### BRIEF DESCRIPTION OF DRAWINGS

The drawings illustrate embodiments of the invention, but should not be construed as restricting the scope of the invention in any way.

FIG. 1 is a bottom view of a flossing device according to an embodiment of the present invention.

FIG. 2 is an inner side view of the flossing device of FIG. 1.

FIG. 3 is a top view of the flossing device of FIG. 1.

FIG. 4 is an outer side view of the flossing device of FIG. 1.

FIG. 5 is a head end view of the flossing device of FIG. 1.

FIG. 6 is a tail end view of the flossing device of FIG. 1.

FIG. 7 is a perspective view of the flossing device of FIG. 1.

FIG. 8 is a view of a flossing device according to an embodiment of the invention being held for cleaning between one's lower teeth.

FIG. 9 is a view of the flossing device of FIG. 8 being held in an inverted position for cleaning between one's upper teeth.

FIG. 10 is a view showing a flossing device held in two positions for cleaning between the back side teeth.

FIGS. 11-12 show a flossing device held for cleaning between one's front teeth.

FIG. 13 shows the transitions, channel and fastener for attaching floss to an embodiment of the flossing device.

FIG. 14 shows an embodiment of the flossing device fitted with floss.

FIG. 15 shows guides for directing the floss in the flossing device.

FIG. 16 shows floss routed through the transitions at the top of the legs of the flossing device.

FIG. 17 shows attached floss conforming to the curvature of the neck of the flossing device.

FIG. 18 is a close up of the fastener with the floss about to be attached.

FIG. 19 is a close up of the fastener with the floss attached.

FIG. 20 is a side view of a fastener.

FIG. 21 shows the legs of a flossing device between the teeth and a brace.

FIG. 22-23 show the legs of a flossing device when tilted between the teeth and a brace.

FIG. 24 is a perspective view of an alternate embodiment of the flossing device.

FIG. 25 is a view of the flossing device in position for cleaning between the lower right back teeth.

FIG. 26 is a view of the flossing device in position for cleaning between the upper right back teeth.

FIG. 27 is a view of the flossing device in position for cleaning between the lower left back teeth.

FIG. 28 is a view of the flossing device in position for cleaning between the upper left back teeth.

### DETAILED DESCRIPTION

Throughout the following description, specific details are set forth in order to provide a more thorough understanding of the invention. However, the invention may be practised without these particulars. In other instances, well known elements have not been shown or described in detail to avoid unnecessarily obscuring the invention. Accordingly, the specification and drawings are to be regarded in an illustrative, rather than a restrictive, sense.

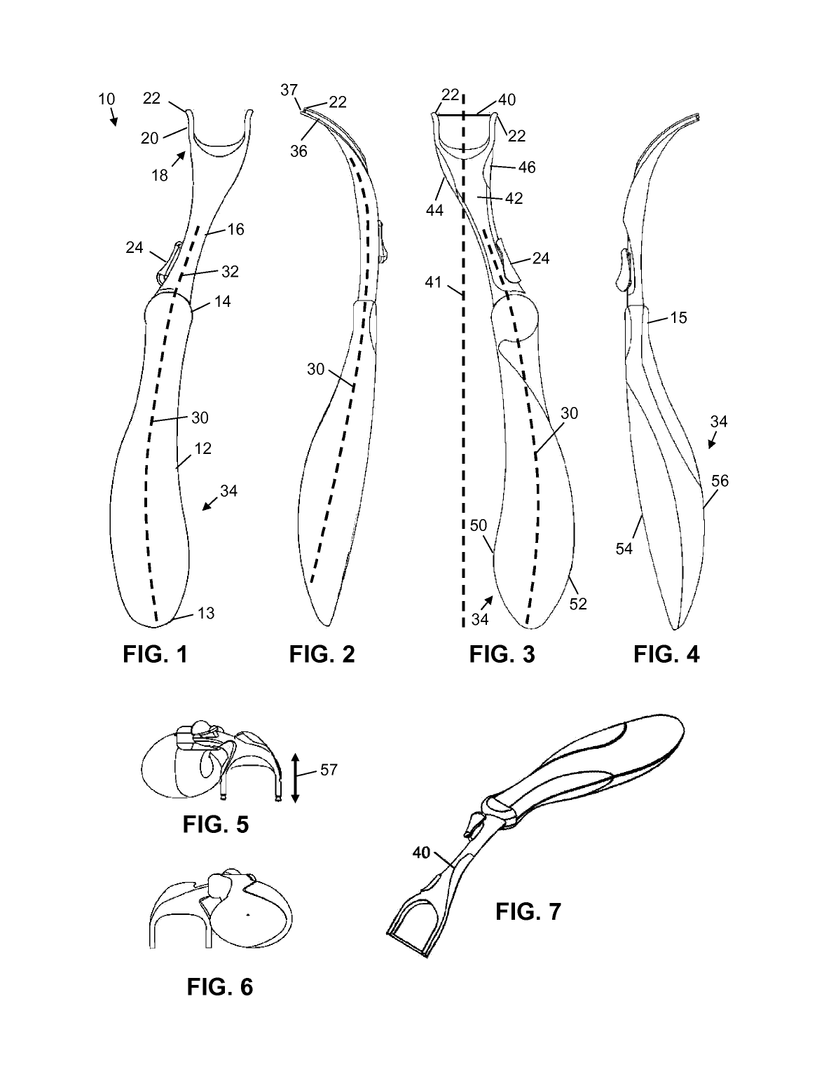

Referring to FIG. 1, a bottom view of a flossing device 10 according to an embodiment of the present invention is shown. This is a view of the underside of the flossing device when it is held in position for cleaning between the lower teeth. The flossing device 10 has a handle 12, with tail end 13 and connecting end 14, which is connected to a neck 16, which in turn terminates at its other end at a head 18. The size of the aperture within the fork in the head 18 is set to match the width of the teeth. The height of the aperture is dimensioned such that the head does not touch the ends of the teeth when the teeth are being flossed close to the gum. In use, due to a firm connection between the hand and handle, the device 10 effectively forms an extension of the hand, from the palm through the fingers to the head 18, permitting greater control over the device. The head has two legs 20, which project downwards from the neck and terminate at tips 22 between which floss is mounted for cleaning between one's teeth. Mounted on the neck 16 is a single fastener 24 to which the two free ends of a length of floss can be attached.

The handle 12 is asymmetrically curved in relation to the head 18 of the flossing device. The curvilinear axis 30 of the handle 12 is shown by a dotted line. The curvilinear axis curves monotonically, but the degree of curvature may change along the axis. A portion of the neck 16 adjacent to the handle 12 may also be asymmetrically curved in relation to the head, its curvilinear axis 32 being an extension of the curvilinear axis 30 of the handle. The handle 12 also has a bulbous portion 34 located towards its tail end 13. If the flossing device is held as intended, the bulbous portion 34 and tail end 13 fit in the same position in the palm of the hand, irrespectively of which way up the device is. The bulbous portion 34 may optionally be weighted.

FIG. 2 is an inner side view of the flossing device, the inner side being defined as the side of the flossing device on the inside of the asymmetric curvilinear axis 30 of the handle 12. In this view we can see one of the channels 36 in the legs 20 of the head 18 of the flossing device 10. These channels 36 are for guiding the floss when it is attached to the flossing device and for securing it while flossing. The channels 36 terminate at the tips 22 of the legs 20. Note that in other embodiments the channels 36 may be on the top or front of the legs. At each tip there is a small cut-out 37 for locating the floss between the tips of the legs. Also shown by a dashed line is the side view of the handle's curvilinear axis 30.

FIG. 3 is a top view of the flossing device 10 with a portion of floss 40 attached only between the tips 22 of the device. The device has a channel 42 which extends from the tops of the channels 36, along the upper surface of the neck 16, to the fastener 24. The channel 42 is flanked by raised guides 44 and 46. The channel 42 and guides 44, 46 are for locating the floss when it is attached to the device 10.

A reference plane 41 is shown, which bisects the line of floss 40 between the tips 22 of the head 18 of the device 10. The floss 40 between the tips 22 is at right angles to, or normal to, the reference plane 41. While it can be seen that the length of floss 40 between the tips is symmetric about the reference plane 41, and most, if not all, of the head 18 is, the handle 12 is clearly asymmetric. The curvilinear axis 30 of the handle is outside of the reference plane 41. The inner side of the handle 12 can also be defined as the surface closest to the reference plane 41, whereas the outer side of the handle can be defined as the surface farthest from the reference plane.

In general, the bulbous portion 34 of the handle 12 has smooth, convex surfaces. The inner surface 50 of the bulbous portion is convex, as is the outer surface 52 of the bulbous portion.

FIG. 4 is an outer side view of the flossing device 10, the outer side being the side farthest from the reference plane 41. The bulbous portion 34 of the handle 12 has upper convex surface 54 and a lower convex surface 56. The upper convex surface 54 extends from the bulbous portion 34 to over most of the upper surface of the handle, whereas the lower convex surface 56 extends less. This is because the bulbous portion 34 is somewhat offset in a direction below the handle. Note also that the upper end 14 of the handle is flattened 15 in order to make it more comfortable to hold between the thumb and side of the forefinger.

FIG. 5 is an end view of the flossing device 10 from the head 18 end of the device. The height 57 of the head 18 of device 10 is chosen such that the device can be used with a comfortable mouth opening, in which the mouth does not need to be opened to a too wide or uncomfortable angle. FIG. 6 is an end view of the tail end 13 of the flossing device 10. FIG. 7 is a perspective view of the flossing device, with a portion of floss 40 located in the channel 42.

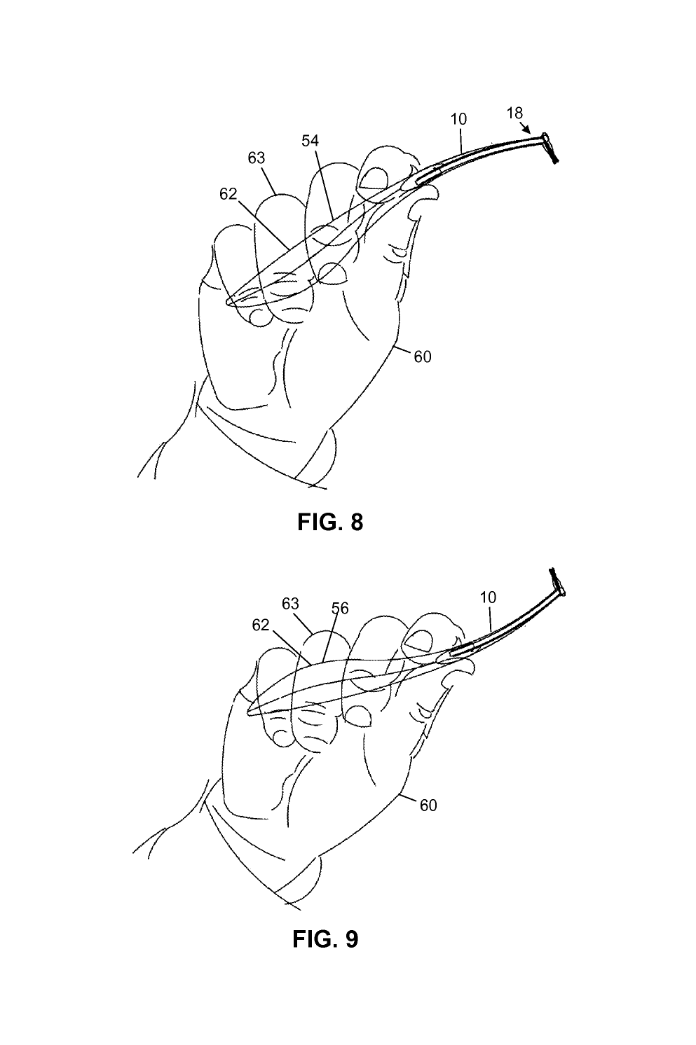

FIG. 8 is a view of a flossing device 10 according to an embodiment of the invention being held for cleaning between one's lower teeth. The upper convex surface 54 of the bulbous portion 34 of the handle 12 is nestled snugly on the insides of the curled fingers of the hand 60, with the fingers being gently curled rather than clenched. The upper convex surface 54 generally follows the natural curvature of the cavity formed by the proximal and middle phalanxes when the fingers of a hand are gently curled. One side of the bulbous portion of the handle is in contact with the palm of the hand. Furthermore, the overall size of the handle is such that the fingers do not need to be tightly clenched to hold the flossing device. The zone of maximum bulge 62 of the bulbous portion 34 of the handle 12 is arranged to be located in or close to the fourth finger 63. As a result, the handle 12 can be gripped solidly with minimal effort, allowing the flossing device 10 to be manipulated bodily by articulating the wrist joint. This is much easier for a user of the flossing device than using fingers to manipulate it. The flossing device 10 is of a generally fixed shape and may be made from a single or multiple components. While it is generally resilient, it may have some flexibility, particularly in the neck, depending on the material or materials it is made from.

Note that in this embodiment the detail of the head 18 is different. As with many other details of the flossing device 10, there can be many variations in the form of the head.

FIG. 9 is a view of the flossing device 10 being held in an inverted position for cleaning between one's upper teeth. In this position, the lower convex surface 56 of the bulbous portion 34 of the handle 12 fits snugly inside the fingers when they are gently curled, albeit with the fingers in a slightly different position compared to when holding the flossing device the other way up. Again, in this position, the maximum bulge 62 in the bulbous portion of the handle is located at or near the fourth finger 63. The cross-sectional circumference of the handle 12 decreases to accommodate the little finger in the vicinity of end 13 of the handle.

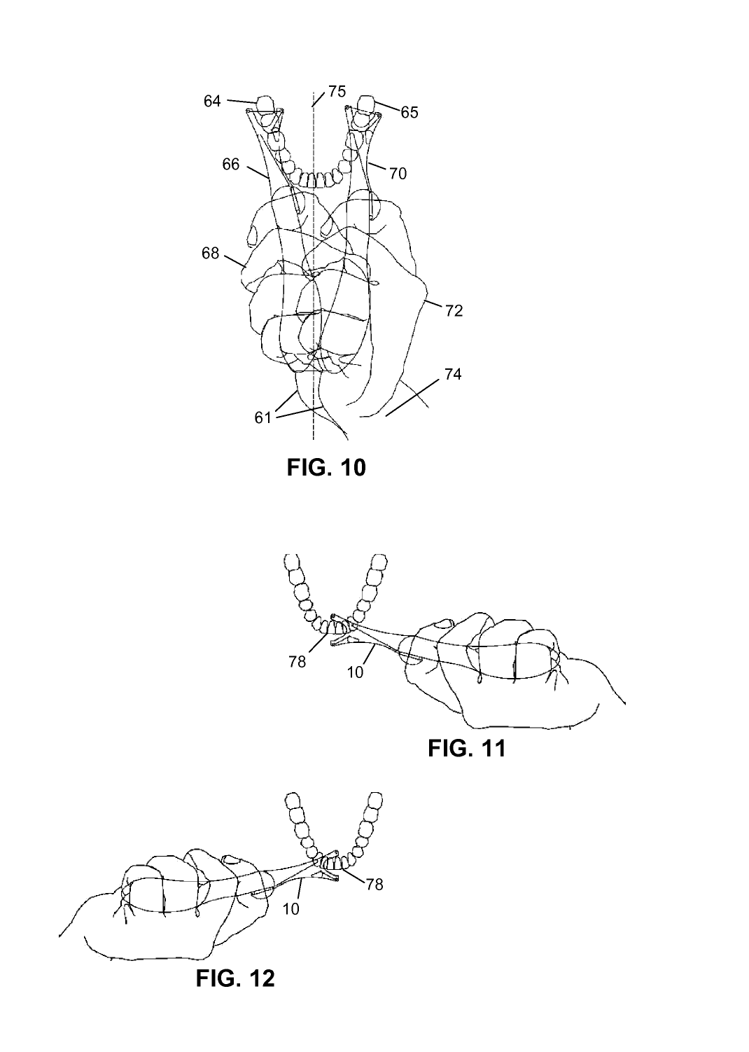

FIG. 10 is a view of a flossing device 10 held in a first position 66 by a user's hand 61 in position 68 for cleaning between the back teeth 64 on one side of the mouth. The flossing device is also shown in a second position 70 with the same hand 61 in position 72, for cleaning between the back teeth 65 on the other side of the mouth. The two positions shown for the hand are only slightly to each side of the centre line 75 through the mouth. Essentially the hand is generally positioned on the centre line 75 through the mouth or in the vicinity of the centre line while flossing the back teeth. The extension or neck 16 is configured to rotate 360 degrees between upper and lower molars of the mouth cavity with a minimum movement of the wrist 74. This helps to reduce incorrect or digging movements when flossing, helping to create a more pleasant and controlled flossing experience.

Note that the hand 61 is a left hand, whereas in the previous diagrams a right hand was shown. While the asymmetric nature of the flossing device 10 results in a significant improvement when holding the device one way up, it has been found that it does not create discomfort while holding it the other way up, or with the other hand. In fact, it has been found to be more comfortable to use the other way round than flossing devices with conventional, symmetric handles. This can be attributed mainly to the bulbous portion 34 of the handle, which compensates for the asymmetric nature of the handle. Still, it is possible to make the flossing device 10 with the curvilinear axis 30 to either side of the reference plane 41.

FIG. 11 shows the flossing device 10 held sideways with respect to the mouth for cleaning between one's front teeth 78. Similarly, FIG. 12 shows the flossing device 10 being held to the other side of the mouth for cleaning between the front teeth 78. Note that sometimes a left hand and sometimes a right hand is shown, to demonstrate the ambidextrous nature of the flossing device.

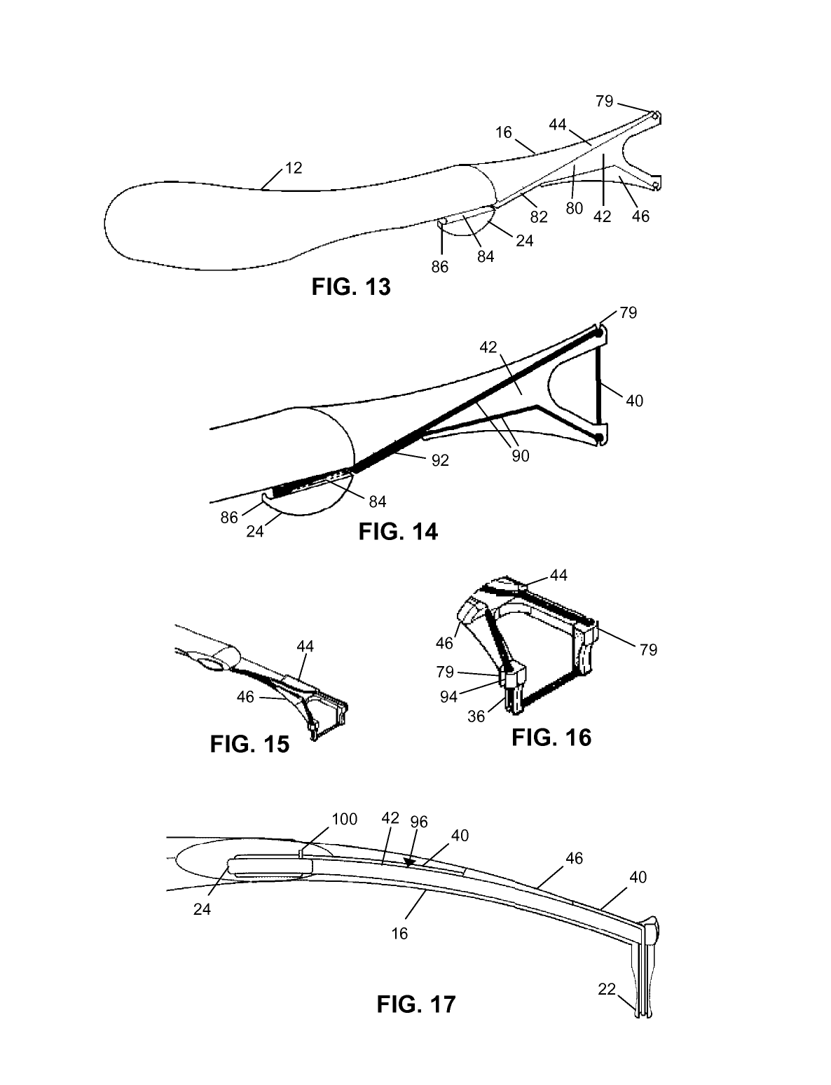

FIG. 13 is a plan view of another embodiment of the flossing device 10. In this embodiment, the fastener 24 is located on the handle 12, rather than on the neck 16. This can be achieved either by positioning the fastener differently compared to other embodiments, or by altering the relative dimensions of the handle and the neck without moving the fastener. The advantage of having the fastener on the handle is that it will be typically outside the mouth during use, i.e. beyond an interbuccal distance from the head. This is so that trailing floss does not tickle or otherwise disturb the inside of the mouth cavity while flossing. In other embodiments, the fastener 24 may straddle the neck 16 and the handle 12. At the top of each of the channels 36 in the side of the legs 22 there are transitions 79 for helping to locate the floss as it passes from the legs 22 of the device to the channel 42, flanked by guides 44, 46. Transitions 79 may be in the form of eyes, eyelets, slots, grooves, clips, etc. The transitions are useful so that the floss can be initially held in place, attached to the head of the device and left there without falling off, so that the user has both hands free if needed to complete the attachment and tightening of the floss. The transitions serve the dual purpose of guiding the floss across an abrupt change of plane as well as fixing it in place.

As the channel 42 extends from the neck 16 to the handle 12, it narrows in region 80, eventually narrowing down to a narrow channel 82, which is intended to accommodate strands of floss coming from both legs 22 of the head 18 and guide them together. The narrow channel 82 leads to groove 84 located around the fastener 24, such that strands of floss from both of the legs can be guided together, at the same time, around the fastener 24. The features of a common channel for guiding the ends of the floss together and a single fastener that can fasten two ends of floss simultaneously make it very convenient for the user to attach floss. Also shown is a hook 86 at the end of the fastener farthest from the head 18, which assists the user to fasten the floss by keeping the floss aligned around the groove 84 while the user is wrapping it around fastener 24. At the head end of fastener 24 is a slot 104 (FIG. 19) into which the floss can be wedged. After wedging, a variation would be to hold the free ends of floss between the index finger and the flossing device 10 to further enhance the locking of the floss in place. This also allows the floss to be easily replaced. Rather than wrapping the floss around a fastener several times, the fastener 24 disclosed here is more of a lock, permitting the securing of floss in the wedge. The aim, when fixing the floss to the device 10, is to create a loop with the floss, place the floss in the transitions, pass both ends of the floss through the hole 86, set the tension in the floss and secure the floss in the wedge and optionally, with the help of the index finger, to retain the floss in the wedge or to reduce the chance of it slipping. The floss is therefore able to be replaced or moved easily. Note that alternatives are possible in place of the wedge. For example, any kind of fastener that can secure the floss can be used, such as a lock, brake or a grip. In general, a lock can be used to refer to any kind of component in a fastener that secures the floss.

FIG. 14 is a view of the upper end of the flossing device 10 showing routing of the floss 40. The floss is supported between the tips, passes through the transitions 79 and into the channel 42. As the channel generally becomes narrower from the head 18 to the base of the neck 16, portions 90 of the floss 40 are typically, but not necessarily, located at each side of the channel 42. The strands of floss from both of the tips come together in channel 82 to form multiple floss strands 92. The multiple floss strands 92 are wrapped around groove 84 in the fastener 24 and over hook 86 in the fastener.

FIG. 15 shows a perspective view of another embodiment with raised guides 44, 46. In embodiments such as this one, the channel may not be continuous since strategic positioning of the guides 44, 46 may be enough to guide the floss along the neck, without it slipping off. FIG. 16 is a close up, showing that there are no channels between the transitions 79 and the guides 44, 46. This is so that, in some embodiments, the tips can be as slim as possible for orthodontic flossing. The transitions 79 each have a split 94 through which the floss 40 can be snapped. By snapping the floss into the transitions 79, it can be kept in place in the channels 36 at the sides of the legs 20.

FIG. 17 is a side view of the upper portion of the flossing device 10, showing floss 40 attached to it. In this view, the floss 40 can be seen to pass behind guide 46, around fastener 24, to terminate at end 100. In particular, the floss 40 conforms to the curvature of the neck 16 of the flossing device. The curvature may be convex or cylindrical, for example, in the region where the floss is in contact with it. The benefit of this extended curved contact area between the floss and the neck is that friction between the floss 40 and the upper curved surface 96 of the neck 16 helps to maintain tension of the floss between the tips 22, to distribute the tension and to thereby reduce the force needed to wrap and maintain the floss around the fastener. To this end, the upper curved surface 96 of the neck may be textured to provide additional friction or include one or more wedges, locks, grips or brakes for the floss to be secured to.

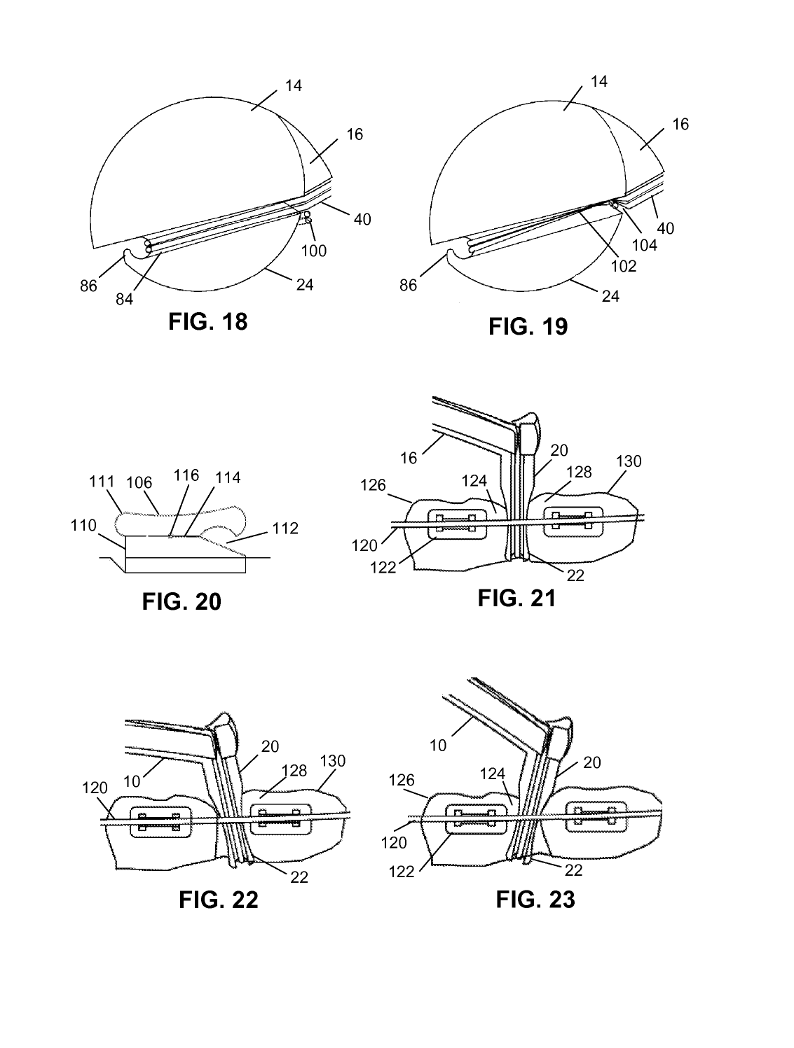

FIG. 18 is a close up of the fastener 24 mounted on the connecting end 14 of the handle. The floss 40 is shown coming from the neck 16, being wrapped around the front side of the fastener 24, over the hook 86 in the fastener and then around the back of the fastener. The groove 84 in the fastener 24 extends around to the rear side of the fastener. Here, the floss is shown to terminate at end 100 for clarity. FIG. 19 is another close up of the fastener 24 with the floss attached in its final position. The end 100 of the floss has been passed over portion 102 of the floss and wedged into slot 104 at the end of the fastener 24, trapping portion 102 of the floss underneath it. The innermost part of the slot 104 is sufficiently tight to hold the floss onto the device 10 while it is being used to clean between the teeth.

FIG. 20 is an alternate example of a fastener 106. The floss can be wrapped around it at groove 110 while being retained in position by cap 111. To complete the attachment of the floss it is wedged into gap 112 and into slot 114, which terminates at point 116. Slot 114 is tight enough to firmly hold the floss while the device is being used. There are many possible variations of the specific features of the fastener. The benefit of a single fastener, or more particularly a single wrap-around point and fastener as disclosed herein, is that it is quicker to use than two separate fasteners, each for one end of the floss.

FIG. 21 shows one leg 20 of a flossing device 10 in a cleaning position between the teeth and a brace attached to the teeth. The other leg is on the other side of the teeth. The brace consists of a wire 120 attached to mounts 122 on the outer surfaces 124, 128 of respective teeth 126, 130. The leg 20 is narrow enough to fit between the inner side of wire 120 of the brace and outer surfaces 124, 128 of the teeth. This allows the tips 22 of the flossing device 10 to reach to the bottom of the gap between the teeth 124, 128 while the brace is still attached to the teeth. FIG. 22 shows the flossing device tilted downwards, resulting in the tips 22 being shifted to the right in order to clean the base of tooth 130. The thickness of the leg 20 is such that it can pass between wire 120 and surface 128 of tooth 130. FIG. 23 shows the flossing device tilted upwards, resulting in the tips 22 being shifted to the left in order to clean the base of tooth 126. The thickness of the leg 20 is such that it can pass between wire 120 and surface 124 of tooth 126.

The force on the head 18, and therefore the line of floss between the tips 22, can more easily be regulated due to the construction of the device 10, so that when manipulating the device, the chances of detaching a dental bracket are reduced.

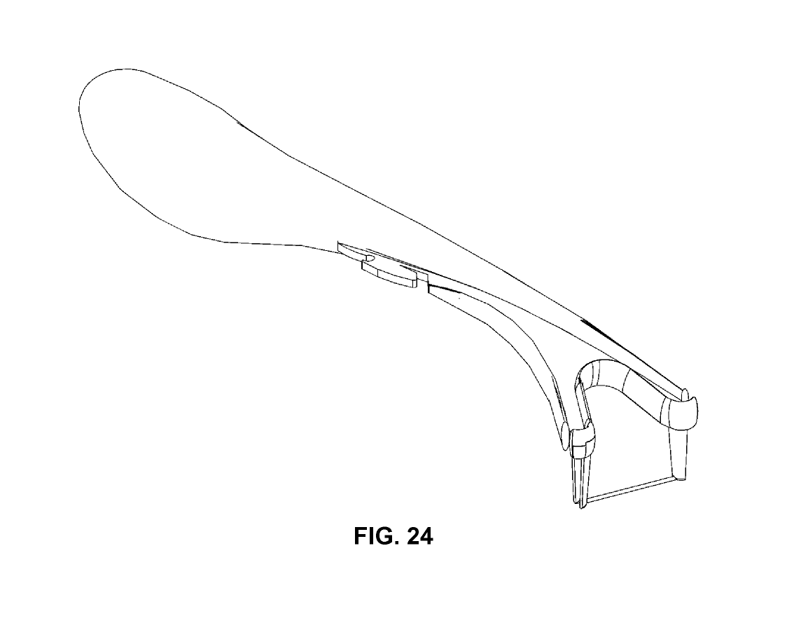

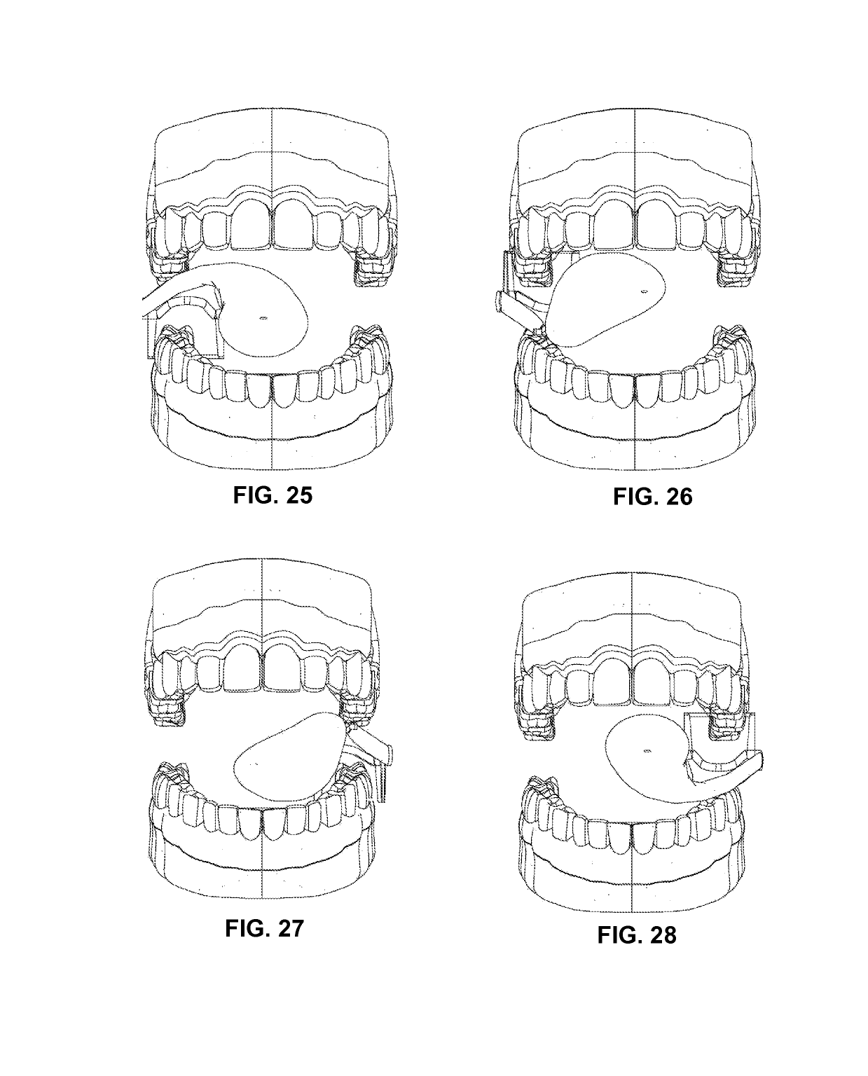

Further views are shown in the following figures. FIG. 24 is a perspective view of an alternate embodiment of the flossing device. FIG. 25 is a view of the flossing device in position for cleaning between the lower right back teeth. FIG. 26 is a view of the flossing device in position for cleaning between the upper right back teeth. FIG. 27 is a view of the flossing device in position for cleaning between the lower left back teeth. FIG. 28 is a view of the flossing device in position for cleaning between the upper left back teeth.

### INDUSTRIAL APPLICABILITY

The disclosed flossing device creates a smoother and more involved flossing experience, conducive to improving one's flossing habits. Due to the features of the flossing device it becomes easier to floss without the use of a mirror. Secure positioning and replacement of floss on the device are more convenient. Orthodontic tips may be included for flossing teeth with braces. The expanded surface of the handle in its bulbous portion permits the distribution of hand contact with it over a larger area, requiring less gripping strength and resulting in the wrist being the main pivot for controlling the angle of the flossing device. The handle allows users to easily control the strength in the tips of the device. The transitions serve the dual purpose of guiding the floss across an abrupt change of plane as well as fixing it in place. The head is angled and dimensioned for facilitating mesial and distal flossing.

### Variations

As one skilled in the art, it is clear that many variation of the flossing device 10 are possible. For example the boundaries between the head and neck, and neck and handle may not necessarily be as clearly defined as shown in the figures herein. The flossing device may be made form a single piece of material where the transitions between the handle, neck and head are gradual, rather than abruptly defined. Another example is that the device could be made to accommodate a double strand of floss, such that there are two lengths of floss between the tips and a quadruple strand accommodated in the channel and wrapped around the fastener. The curvature of the flossing device, whether it be the curvature of the handle, or the neck and the handle, may be a portion of a spiral. The flossing device can be made in different sizes, to suit children and adults. Channels may be of different depths at different locations in the device. The neck may be straight rather than curved, the axis of the neck continuing inline with, or at an angle to, the curvilinear axis of the handle. For most comfortable use, the location of the interface between the neck and the handle should be in the vicinity of the centre of the front of the mouth when the line of floss is positioned to clean between the back teeth. The form of the bulbous portion of the handle may be different. The handle may be symmetric in itself, provided that the neck is curved and the handle is located to one side of the reference plane, either parallel to it or at an angle to it. Many other variations are possible without departing from the scope of the following claims:

1. A flossing device comprising:
a head having two tips between which floss can be mounted in a line, wherein the line defines a reference plane that bisects the line and is perpendicular to the line;
a neck joined to the head;
a handle joined to the neck, wherein the handle has a curvilinear axis that is outside the reference plane.

2. The flossing device of claim 1, further comprising a single fastener for wrapping multiple strands of floss around and for attaching said multiple strands to the flossing device.

3. The flossing device of claim 2, wherein the single fastener is mounted on the handle.

4. The flossing device of claim 2, wherein the single fastener is mounted on the neck.

5. The flossing device of claim 2, wherein the single fastener is located beyond an interbuccal distance from the head.

6. The flossing device of claim 1, wherein the curvilinear axis has an outer side that is facing away from the reference plane and the outer side is convex.

7. The flossing device of claim 1, wherein the curvilinear axis curves monotonically.

8. The flossing device of claim 1, wherein the handle comprises a bulbous portion.

9. The flossing device of claim 8, wherein the handle has an upper half adjacent to the neck and a lower half remote from the neck, and the bulbous portion is substantially located in the lower half.

10. The flossing device of claim 1, further comprising a channel between the two tips and the fastener for guiding multiple strands of floss simultaneously.

11. The flossing device of claim 1, wherein the neck has a curved portion over which the floss is guided, said curved portion providing friction to assist in maintaining tension in the line of floss.

12. The flossing device of claim 1, wherein the neck has a curvilinear axis that is an extension of the curvilinear axis of the handle.

13. The flossing device of claim 1, wherein the single fastener comprises a lock into which the floss can be secured in order to maintain tension in the line of floss.

14. The flossing device of claim 1, the head further comprising two transitions each for holding the floss in position and for guiding the floss through a change of plane.

15. A method of manufacturing a flossing device comprising:
forming a head having two tips between which floss can be mounted in a line, wherein the line defines a reference plane that bisects the line and is perpendicular to the line;
forming a neck joined to the head, the neck having a curved portion over which the floss is guided, said curved portion providing friction to assist in maintaining tension in the line of floss;
forming a handle joined to the neck, wherein the handle has a monotonically curved curvilinear axis that is outside the reference plane and a bulbous portion, wherein the curvilinear axis has an outer side that is facing away from the reference plane and the outer side is convex;
attaching, to the handle or neck, a single fastener for wrapping multiple strands of floss around and for attaching said multiple strands to the flossing device, the fastener comprising a slot into which the floss can be wedged in order to maintain tension in the line of floss; and
forming a channel between the two tips and the fastener for guiding multiple strands of floss simultaneously.
